(19) United States
(12) Patent Application Publication
(10) Pub. No.: US 2025/0110758 A1
(43) Pub. Date: Apr. 3, 2025

(54) SYSTEM AND METHOD FOR PROVIDING AN ADAPTIVE USER INTERFACE (UI) NAVIGATION

(71) Applicant: Samsung Electronics Co., Ltd., Suwon-si (KR)

(72) Inventors: Vipul GUPTA, Hisar (IN); Ankur AGRAWAL, Agra (IN); Vaibhav NEGI, Jaipur (IN)

(21) Appl. No.: 18/978,368

(22) Filed: Dec. 12, 2024

Related U.S. Application Data
(63) Continuation of application No. PCT/KR2023/004025, filed on Mar. 27, 2023.

(30) Foreign Application Priority Data
Sep. 13, 2022 (IN) 202211052274

(51) Int. Cl. G06F 9/451

(52) U.S. Cl. CPC G06F 9/451

(57) ABSTRACT

A method for providing an adaptive user interface (UI) navigation on a user equipment (UE) using a machine learning (ML) model is provided. The method includes obtaining a user context from a user action, wherein the user action is associated with navigating a plurality of UI components at a UI of the UE, determining an activity based on the user action, wherein the activity is stored in an activity stack, extracting at least one feature from the plurality of UI components during navigation based on the user context, determining a user navigation behavior from the at least one action category and the user context, wherein the user navigation behavior is indicative of learning of at least one required and at least one non-required activity in the activity stack during navigation of the plurality of UI components, and removing the at least one non-required activity from the activity stack such that during navigation one or more of the plurality of UI components are removed providing the adaptive UI navigation on the UE.

### CROSS-REFERENCE TO RELATED APPLICATION(S)

This application is a continuation application, claiming priority under § 365 (c), of an International application No. PCT/KR2023/004025, filed on Mar. 27, 2023, which is based on and claims the benefit of an Indian patent application Ser. No. 20/221,1052274, filed on Sep. 13, 2022, in the Indian Intellectual Property Office, the disclosure of which is incorporated by reference herein in its entirety.

### BACKGROUND

### 1. Field

The disclosure relates to the field of mobile computing environments. More particularly, the disclosure relates to system and method for providing adaptive application navigation in a mobile computing environment.

### 2. Description of Related Art

Electronic devices have become a central element in human lives. Every day-to-day activity is surrounded by electronic devices and is done with their usage. Particularly, a smartphone has become an all-time partner for a user. The users are often engaged in operating applications installed on the smartphone and may require a responsive, dynamic, adaptive user interface (UI) while navigating within the application or between multiple applications.

Part of a great user experience is nurturing users' feelings of control over the UI. While navigating the application the user may navigate through multiple screens or UI components. Thus, leading to a creation of multiple activities in an activity stack of an operating system, such as android. The multiple activities may typically be categorized into-required activities and non-required activities. Due to static navigation in the operating system, the user must go-through all the required activities and non-required activities while navigating through the application. The UI in the smart phone should be dynamic enough to be able to quickly correct user's mistakes or may be able to predict where to navigate within the application or between multiple applications, thus avoiding the non-required activity.

The existing technology provides static navigation control schemes wherein the user is navigated to go back to each previous screen or each of the previous activity present in the activity stack. The navigation flow is always statically defined by an application developer, thus neither the user could modify it nor there is any intelligence involved during the navigation. The static flow of activities makes the activities alive for always in the smartphone until the user removes it from the activity stack by pressing back buttons in the smart phone i.e., navigating through each of the activity multiple times. In addition, each activity present in the activity stack consumes some smart phone resources, such as memory, battery, storage, data, or the like. Thus, the presence of non-required activities in the activity stack makes the performance of the application poor and smartphone sluggish.

Further, this may create a problem of back button fatigue where the user gets tired of multiple unnecessary back button clicks to finish the activity stack and remove/destroy activities from random access memory (RAM) of the smartphone.

In applications, the user may tend to transfer their knowledge of one application from the task they perform to experience the results in another application and expect that the navigation between applications would intelligently adapt for them as per the task performed but that is not the way the existing UI in the smartphones may perform. The existing UI in smartphones may allow navigation from whichever direction or through the activities as performed by the user serially. Unfortunately, the existing static navigation designs are the only way of moving up and down amongst the applications.

Accordingly, there is a need for a system and method to provide a user-based adaptations in the UI to avoid user fatigue, improve performance of the application and the smartphone.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for providing an adaptive user interface (UI) navigation.

Additional aspects will be set forth in part in the description which follows and, in part, will be apparent from the description, or may be learned by practice of the presented embodiments.

In accordance with an aspect of the disclosure, a method for providing an adaptive user interface (UI) navigation on a user equipment (UE) using a machine learning (ML) model is provided. The method includes obtaining a user context from a user action, wherein the user action is associated with navigating a plurality of UI components at a UI of the UE, determining an activity based on the user action, wherein the activity is stored in an activity stack, extracting at least one feature from the plurality of UI components during navigation based on the user context, determining at least one action category based on the extracted at least one feature and the user context, determining a user navigation behavior from the at least one action category and the user context, wherein the user navigation behavior is indicative of learning of at least one required and at least one non-required activity in the activity stack during navigation of the plurality of UI components, and removing the at least one non-required activity from the activity stack such that during navigation one or more of the plurality of UI components are removed providing the adaptive UI navigation on the UE.

In accordance with another aspect of the disclosure, a UE for providing an adaptive UI navigation using an ML model is provided. The UE includes memory storing one or more computer programs, one or more processors communicatively coupled to the memory, wherein the one or more computer programs include computer-executable instructions that, when executed by the one or more processors individually or collectively, cause the UE to obtain a user context from a user action, wherein the user action is associated with navigating a plurality of UI components at a UI of the UE, determine an activity based on the user action, wherein the activity is stored in an activity stack, extract at least one feature from the plurality of UI components during navigation based on the user context, determine at least one action category based on the extracted at least one feature and the user context, determine a user navigation behavior from the at least one action category and the user context, wherein the user navigation behavior is indicative of learning of at least one required and at least one non-required activity in the activity stack during navigation of the plurality of UI components, and remove the at least one non-required activity from the activity stack such that during navigation one or more of the plurality of UI components are removed providing the adaptive UI navigation on the UE.

In accordance with another aspect of the disclosure, one or more non-transitory computer-readable storage media storing computer-executable instructions that, when executed by one or more processors of a UE individually or collectively, cause the UE to perform operations are provided. The operations include determining an activity based on a user action, wherein the activity is stored in an activity stack, extracting at least one feature from the plurality of UI components during navigation based on the user context, determining at least one action category based on the extracted at least one feature and the user context, determining a user navigation behavior from the at least one action category and the user context, wherein the user navigation behavior is indicative of learning of at least one required and at least one non-required activity in the activity stack during navigation of the plurality of UI components, and removing the at least one non-required activity from the activity stack such that during navigation one or more of the plurality of UI components are removed providing the adaptive UI navigation on the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic block diagram depicting an environment for implementation of a system for providing an adaptive user interface (UI) navigation on a user equipment (UE) using a machine learning (ML) model, according to an embodiment of the disclosure;

FIG. 2 illustrates a schematic block diagram depicting an implementation according to an embodiment of the disclosure;

FIG. 3A illustrates a schematic block diagram of modules/software components of a system for providing an adaptive UI navigation on a UE using an ML model according to an embodiment of the disclosure;

FIG. 3B illustrates a schematic block diagram of a user equipment for providing an adaptive UI navigation using a ML model, according to an embodiment of the disclosure;

FIG. 4 illustrates a process flow comprising a method for providing an adaptive UI navigation on a UE using an ML model according to an embodiment of the disclosure;

FIG. 5A illustrates a process flow to determine an action category for a user action by applying a feature averaging and categorizing a user action according to an embodiment of the disclosure;

FIG. 5B illustrates a process flow for providing an adaptive UI navigation on a UE using an ML model according to an embodiment of the disclosure;

FIG. 6 illustrates a use case for determining a user navigation behavior to determine a required and a non-required activity in an activity stack during navigation according to an embodiment of the disclosure;

FIG. 7 illustrates a use case for determining a user navigation behavior to determine a required and a non-required activity in an activity stack during navigation according to an embodiment of the disclosure; and

FIG. 8 illustrates a use case for representing a lifecycle of an activity after implementing an adaptive UI navigation on a UE using an ML model, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The disclosure is directed towards a method and system for providing an adaptive user interface (UI) navigation on a user equipment (UE) using a machine learning (ML) model. In the disclosure, as a user navigates through an application installed in the UE or between multiple applications, there are required, and non-required activities being generated. Such required and non-required activities are stored in an activity stack.

A collection of activities that users interact with when trying to do something in the application may be termed as a task. These activities are arranged in the activity stack or may be known as the back stack, in the order in which each activity is opened. For instance, an application related to email may have one activity to show a list of new messages. When the user selects a message, a new activity opens to view that message. This new activity is added to the activity stack. Then, if the user presses or gestures back, that new activity is finished and removed from the activity stack. The disclosure provides adaptive UI navigation by determining and removing the non-required activities from the activity stack.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

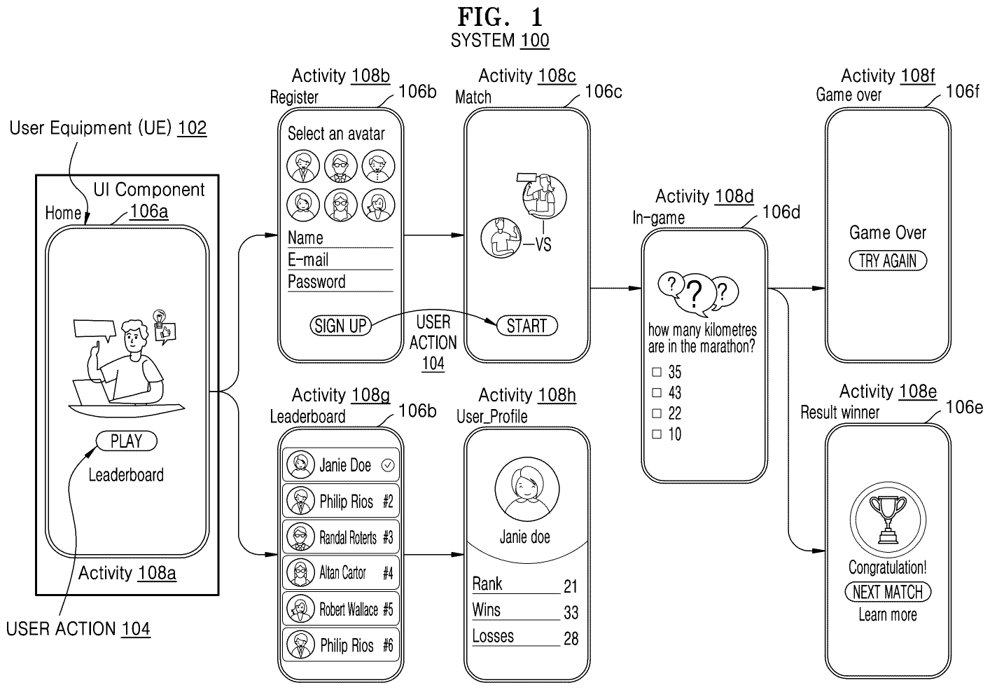

FIG. 1 illustrates a schematic block diagram depicting an environment for an implementation of a system for providing an adaptive user interface (UI) navigation on a user equipment (UE) using a machine learning (ML) model according to an embodiment of the disclosure.

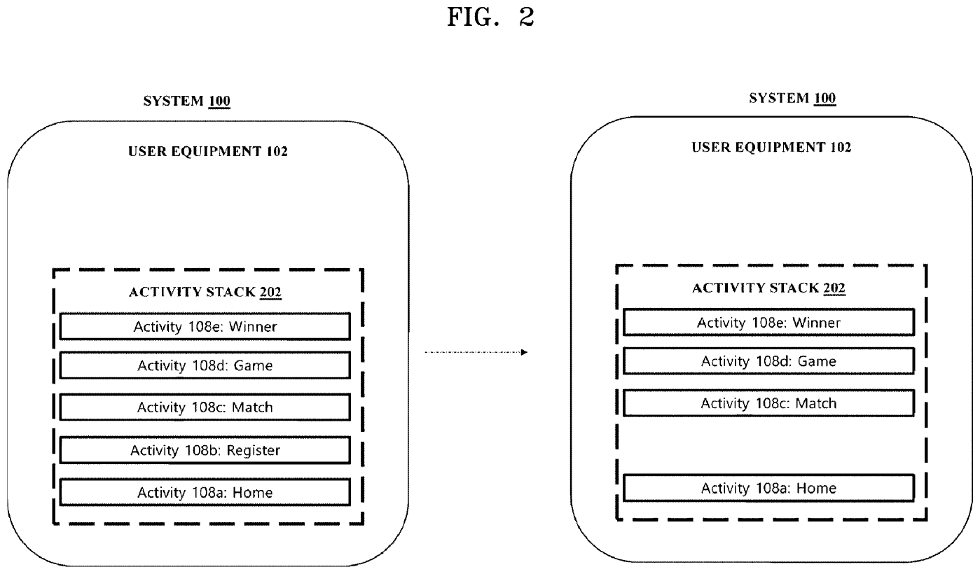

FIG. 2 illustrates a schematic block diagram depicting an implementation according to an embodiment of the disclosure.

Referring to FIGS. 1 and 2, for the sake of brevity, a system 100 for providing an adaptive UI navigation on a UE 102 is hereinafter interchangeably referred to as the system 100.

Referring to FIGS. 1 and 2, the system 100 may be implemented in the UE 102, the applications installed in the UE 102 and running on an operating system (OS) of the UE 102 that generally defines a first active user environment. The OS typically presents or Odisplays the application through a graphical user interface (“GUI”) of the OS. Other applications may be running on the operating system of the UE 102 but may not be actively displayed. In an example, the UE 102 may be but not limited to, a laptop computer, a desktop computer, a Personal Computer (PC), a notebook, a smartphone, a tablet, a smart watch and alike. In the example, the operating system in the UE 102 may be an android operating system.

In an embodiment of the disclosure, the user may be operating the application which typically consists of performing a user action 104. The user action 104 may typically consists of selecting action buttons or icons at a UI of the UE 102 to perform tasks. Further, the user action 104 is associated with navigating a UI component 106 at the UI, thus creating an activity 108 corresponding to the user action 104. Referring to FIG. 1, in an example embodiment of the disclosure, the UI of the UE 102 displays the UI component 106a as part of the application say a gaming application. The UI component may include a ‘play’ button and the user may perform the user action 104 through a touch input which is typically provided by pressing the ‘play’ button on the touch display of the UE 102. The selection of the gaming application by the user creates the activity 108a representative of a home screen of the gaming application.

In the example, as the UE 102 receives the user action 104, the user navigates to the UI component 106b thus creating the activity 108b i.e., the user registers a profile in the game application. Similarly, upon subsequent user action 104, the user navigates through UI components 106a-106h and creating multiple activity 108a-108b corresponding to every user action 104 and UI component 106a-106h. As illustrated in the example, as the user navigates to the UI component 106h, the activity stack stores every activity 108a-108h. In an embodiment of the disclosure, the activity stack 202 stores activity 108-108e when the user finishes the game by activity 108e. As the user finishes the task associated with the game application and reaches the activity 108e i.e., a game is completed, the user may require navigating back to the UI component 106a i.e., the home screen of the gaming application to restart next game. In this scenario, as the user navigate away from the activity 108e, the user may not desire to again navigate through the UI component 106b and rather desire to reach the UI component 106a directly i.e., at the activity 108a. Therefore, in an implementation of the disclosure, the system 100 determines the activity 108b as a non-required activity and remove it from the activity stack.

Referring to FIG. 2, the activity stack 202 may include the activities 108a-108e created and stored as a result of user action 104 while navigating the UI components 106a-106e at the UI of the UE 102.

Referring to FIG. 2 the system 100 determines the activity 108b as the non-required activity and removes the same from the activity stack 202. Thus, facilitating a quicker, smoother, personalized user experience and saving resources, such as RAM, battery, or the like, for faster UE 102 performance.

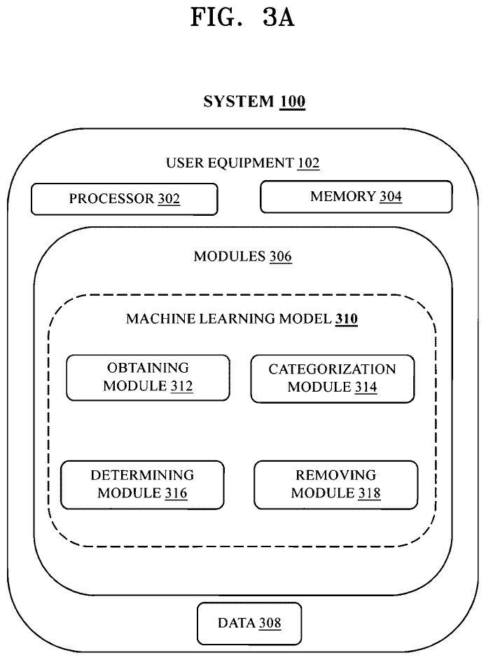

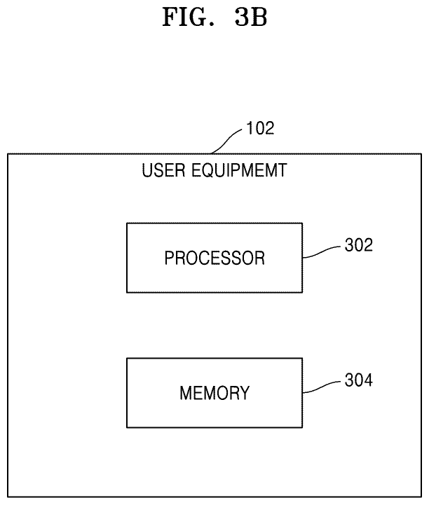

FIG. 3A illustrates a schematic block diagram of modules/software components of a system for providing an adaptive UI navigation on a UE using a ML model according to an embodiment of the disclosure.

Referring to FIG. 3A, the UE 102 may include, but is not limited to, a processor 302, memory 304, modules 306, and data 308. The modules 306 and the memory 304 may be coupled to the processor 302.

The processor 302 can be a single processing unit or several units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is adapted to fetch and execute computer-readable instructions and data stored in the memory 304.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The modules 306, amongst other things, include routines, programs, objects, components, data structures, or the like, which perform particular tasks or implement data types. The modules 306 may also be implemented as, signal processor(s), state machine(s), logic circuitries, and/or any other device or component that manipulates signals based on operational instructions.

Further, the modules 306 can be implemented in hardware, instructions executed by a processing unit, or by a combination thereof. The processing unit can comprise a computer, a processor, such as the processor 302, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the disclosure, the modules 306 may be machine-readable instructions (software) which, when executed by a processor/processing unit, perform any of the described functionalities.

In an embodiment of the disclosure, the modules 306 may include the machine learning (ML) model 310 trained using a few-shot learning method. The ML model 310 may include an obtaining module 312, a categorization module 314, a determining module 316, and a removing module 318. The obtaining module 312, the categorization module 314, the determining module 316, and the removing module 318 may be in communication with each other. The data 308 serves, amongst other things, as a repository for storing data processed, received, and generated by one or more of the modules 306.

Referring to FIGS. 1, 2, 3A, and 3B, the obtaining module 312 may be configured to obtain a user context from the user action 104. Further, the obtaining module 312 may be configured to determine the user action 104 based on the navigation of the UI components 106. In an embodiment of the disclosure, as the user may take multiple user action 104 while navigating the UI components 106 at the UI of the UE 102, the obtaining module 312 may be configured to analyze each of the user action 104 on the UE 102.

Further, the obtaining module 312 is configured to filter the user action 104 to remove a non-relevant user action. The obtaining module 312 is then configured to extract a plurality of parameters of each of the UI component 106, such as a touch input, a device orientation, a network condition based on the user action 104. The obtaining module 312 is configured to obtain the user context based on the user action 104 and the extracted plurality of parameters. In an example, the user context is indicative of the task the user would desire to accomplish while performing the user action 104. In the example, the parameters, such as but not limited to a touch input, a device orientation, a network condition based on the user action 104, may be extracted from the UI component 106.

Further, the obtaining module 312 is configured to determine the activity 108 based on the user action 104 performed by the user while navigating the UI components 106 at the UI of the UE 102. The obtaining module 312 is configured to store the determined activity 108 in the activity stack 202. The obtaining module 312 is in communication with the categorization module 314.

In an embodiment of the disclosure, the categorization module 314 may be configured to determine an action category for the user action 104 by applying the feature averaging for categorizing the user action. The categorizer module 314 is configured to extract a feature from the UI component 106 generated during navigation based on the user context. The extracted feature from the UI component 106 may be subjected to feature averaging for categorizing the user action 104. The categorization module 314 may include a pre-defined action category. The pre-defined action category may be indicative of the task performed by the user on the UI while performing the user action 104. Referring to FIG. 1, the pre-defined action category of the UI components 106a-106f may indicate the game application. In the example, the user is performing the task of playing the game using the game application. Thus, every user action 104 may correspond to respective the action category.

Now, to categorize the user action 104 into one of the action category, the categorization module 314 is configured to assign a customized weightage to the action category and categorize the features extracted from each of the UI components 106 during navigation, into the action category corresponding to the user action based on the customized weightage. Thus, the categorization module 314 determines the action category for the corresponding user action 104. In an example, the categorization module 314 may be configured to also create a new action category for the user action 104 in case the features extracted from the user action 104 does not relate to any of the action category pre-defined in the ML model 310. The categorizer module 314 is in communication with the determining module 316.

In an embodiment of the disclosure, the determining module 316 is configured to determine a user navigation behavior from the action category and the user context. In an example, the user navigation behavior is indicative of learning of a required activity 108 and the one non-required activity 108 in the activity stack 202 during navigation of the UI components 106 by the user at the UI of the UE 102. The determining module 316 forms a part of the ML model 310. The determining module 316 is trained and configured to map the action category and the user context obtained from the user action 104 with the user navigation behavior.

In an example, the determining module 316 may be trained to determine the user navigation behavior from the action category pre-defined in the categorization module 314. In an example, a training-set is prepared, which typically consists of a base-class user action. In the example, the base-class user action may be a set of pre-determined steps to perform the pre-determined task. The action category is already known and pre-defined for the base-class user action. Accordingly, the determining module 316 may be configured to determine the UI components 106 generated during navigation while performing the base-class user action as part of training the determining module 316.

In continuance with training the determining module 316, the determining module 316 may be configured to assign a base-class weights to the base-class user action and create a model classifier. In an example, the model classifier may be configured to perform classification of the user action 104 based on the base-class weights to determine the user navigation behavior upon receiving the user action 104 is different from the base class user action.

In the example, the features are extracted for the user action 104 upon determining that the user action 104 performed may be different from the base class user action. The user action 104 is then categorized into one of the action categories.

The determining module 316 may be configured to reassign the base-class weights in the model classifier based on the user action 104. Thus, adapted weights are created in the model classifier depending on the user action 104. Accordingly, the determining module 316 may be configured to update the model classifier based on the reassigned base-class weights and the user action 104 and further classify the user action 104 based on the updated model classifier.

Thus, the determining module 316 is trained and may be configured to determine the user navigation behavior based on the categorized extracted feature, the mapped action category, and the user context to determine the required and the non-required activity 108 in the activity stack 202 during navigation of the UI components 106. The determining module 316 is in communication with the removing module 318.

In an embodiment of the disclosure, the removing module 318 is configured to remove the non-required activity 108 from the activity stack 202 such that during navigation of the UI components 106 are removed providing the adaptive UI navigation on the UE 102 to the user.

FIG. 3B illustrates a schematic block diagram of a user equipment for providing an adaptive UI navigation using an ML model according to an embodiment of the disclosure.

Referring to FIG. 3B, the user equipment 102 may include at least one processor 302 and memory 304. In some embodiments, the user equipment 102 exclude at least one of these components or may add at least one other component. It should be noted that FIG. 3B is merely one example of a particular implementation and is intended to illustrate the types of components that may be included as part of the user equipment 102. According to embodiments of this disclosure, an user equipment 102 is included in the network configuration.

The processor 302 includes one or more processing devices, such as one or more microprocessors, microcontrollers, digital signal processors (DSPs), application specific integrated circuits (ASICs), or field programmable gate arrays (FPGAs). In some embodiments, the processor 302 includes one or more of a central processing unit (CPU), an application processor (AP), a communication processor (CP), or a graphics processor unit (GPU). The processor 302 is able to perform control on at least one of the other components of the user equipment 102 and/or perform an operation or data processing relating to communication or other functions.

The processor 302 can be a single processing unit or several units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is adapted to fetch and execute computer-readable instructions and data stored in the memory 304.

The memory 304 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

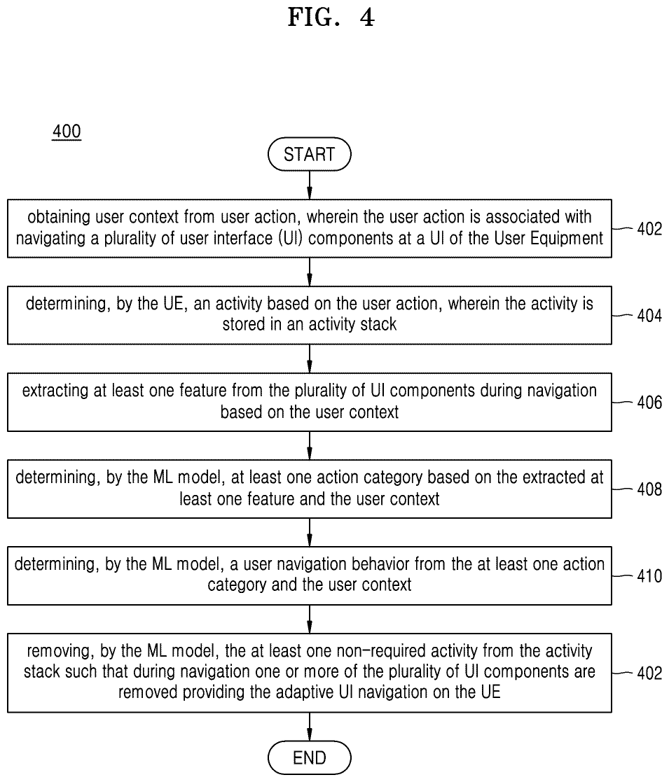

FIG. 4 illustrates a process flow comprising a method for providing an adaptive UI navigation on a UE using an ML model according to an embodiment of the disclosure.

Referring to FIG. 4, a method 400 may be a computer-implemented method executed, for example, by the UE 102 and the ML model 310. For the sake of brevity, constructional and operational features of the system 100 that are already explained in the description of FIGS. 1, 2, 3A, and 3B are not described in the description of FIG. 4.

At operation S402, the method 400 may include obtaining the user context from the user action 104. In an example, the user action 104 is associated with navigating the UI components at the UI of the UE 102. In an example, obtaining the user context comprises determining the user action 104 based on navigation of the UI components. The method 400 includes filtering the user action 104 to remove a non-relevant user action. The parameters are extracted from the UI components. In an example, the parameters may include a touch input, a device orientation, a network condition based on the user action 104. Further, the user context is obtained based on the user action 104 and the parameters extracted.

At operation S404, the method 400 may include determining the activity 108 based on the user action 104. In an example, the activity 108 is stored in the activity stack 202.

At operation S406, the method 400 may include extracting the feature from the UI component 106 during navigation based on the user context.

In continuation with operation S406 at operation S408, the method 400 may include determining the action category based on the extracted feature and the user context. The method 400 may include, performing the feature averaging on the extracted features of each of the UI components. Further, the method 400 may include assigning the customized weightage to the action category. In an example, the action category may be pre-defined and is corresponding to the user action 104.

The method 400 may include categorizing the extracted features of each of the UI components into the action category corresponding to the user action based on the customized weightage.

At operation S410, the method 400 may include determining the user navigation behavior from the action category and the user context. The user navigation behavior is indicative of learning the required and the non-required activity in the activity stack 202 during navigation of the UI components 106.

The method 400 may include mapping the action category and the user context for determining the user navigation behavior. In an example, the user navigation behavior is determined based on the categorized extracted feature, the mapped at least one action category and the user context. Thus, the method 400 may include learning the user navigation behavior typically comprising of determining the required activity 108 and the non-required activity 108 in the activity stack 202 during navigation of the UI components 106.

In an embodiment of the disclosure, the method 400 may include training the ML model 310 to determine the user navigation behavior from the pre-defined action category. In an example, training the ML model 310 through the few-shot learning technique may include determining the UI components 106 during navigation while performing the base-class user action. The base-class user action is indicative of a training-set including the user action. The action category for base-class user action is known and pre-defined. Further, in the method 400 training the ML model 310 may include assigning a base-class weights to the base-class user action and creating a model classifier for the classification of the user action based on the base-class weights to determine the user navigation behavior.

In an embodiment of the disclosure, the method 400 may include upon determining that the user action 104 is different from the base-class user action, reassigning the base-class weights based on the user action 104 to create adapted weights. The method 400 includes updating the model classifier based on the reassigned base-class weights and the user action 104 thus, classifying the user action 104 based on the updated model classifier.

At operation S412, the method 400 may include removing the non-required activity from the activity stack 202 such that during navigation the UI components are removed providing the adaptive UI navigation on the UE 102 to the user.

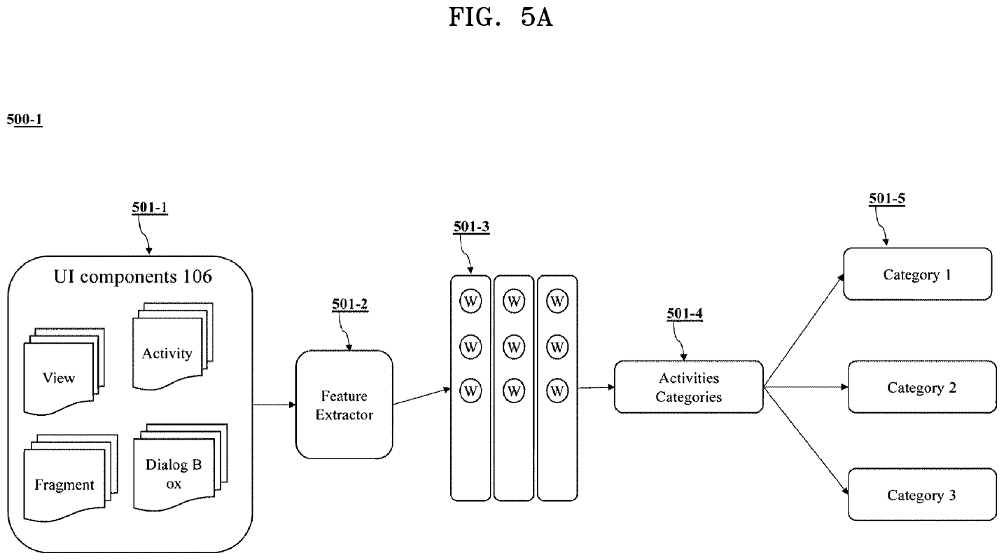

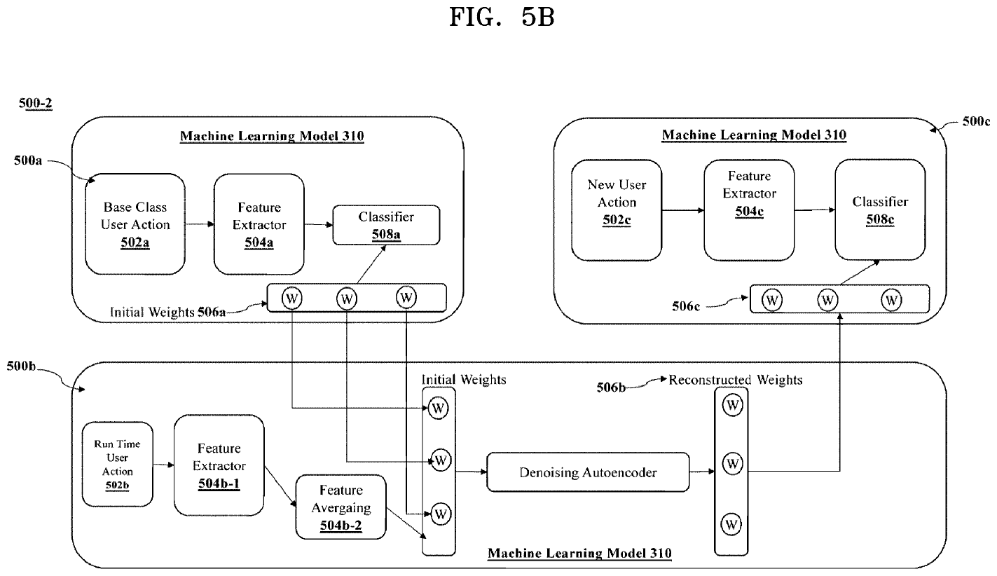

FIG. 5A illustrates a process flow to determine an action category for a user action by applying a feature averaging and categorizing a user action 104 according to an embodiment of the disclosure.

Referring to FIG. 5A, a process flow 500-1 is implemented by the categorization module 314. In an example at block 501-1, the UI components 106 may be generated during navigation based on the user context.

At block 501-2 in the process flow 500-1, the features are extracted from the UI components 106.

At block 501-3 in the process flow 500-1, the extracted features are converted into feature vectors for categorizing the user action 104.

At block 501-4 in the process flow 500-1, the categorization module 314 subject the feature vectors to feature averaging for categorizing the user action 104.

At block 501-5 in the process flow 500-1, the categorization module 314 may include the pre-defined action category. The pre-defined action category may be indicative of the task performed by the user on the UI while performing the user action 104. Each of the pre-defined action categories may have a customized weight assigned to it. The features extracted for each of the UI components 106 are correlated with the pre-defined action category to classify the user action 104 accordingly.

Thus, in accordance with the process flow 500-1, the categorization module 314 may determine the action category for the corresponding user action 104 based on the feature averaging. The few-shot learning technique allows the categorization module 314 to consume less amount of user data for assigning customized weightage to the action category. Similarly, the categorization module 314 may also be configured to create any other new action category apart from the existing pre-defined category, corresponding to the user action 104. The new action category may be created in case the features extracted from the user action 104 may not relate to any of the pre-defined action categories in the ML model 310.

FIG. 5B illustrates a process flow for providing an adaptive UI navigation on a UE using an ML model according to an embodiment of the disclosure.

Referring to FIG. 5B, at section 500a, the process flow 500-2 may include the training of the ML model 310. The ML model 310 is trained using the few-shot learning technique. At section 500a, the base-class user action, typically includes the training-set labelled with the identified action category for the base-class user action. Thus, the action category and the user context related to the base-class user action are already known and pre-defined.

At block 502a in the section 500a, the initial learning or the training for the ML model 310 is performed using the base-class user action.

At block 504a in the section 500a, the features are extracted from the base-class user action. In the example, the features are extracted from the UI components present in the base-class user action based on the user context.

At block 506a in the section 500a, the base-class weights are assigned to the base-class user action. The base-class weights may provide the learnable parameters of the machine learning model 310 to the model classifier for determining the user navigation behavior based on the base-class user action.

At block 508a in the section 500a, the model classifier is created for the classification of the base-class user action based on the base-class weights to determine the user navigation behavior.

Now in continuation with the section 500a, at section 500b in the process flow 500-2 may include the ML model 310 adapting the model classifier to determine both the user action 104 and the base-class user action.

At block 502b in the section 500b, includes the user action 104 received at run-time of the trained ML model 310. The user action 104 received in the section 500b is different from the base-class user action.

At block 504b-1 in the section 500b, the features are extracted from the UI components 106 during navigation while the user performs the user action 104. At block 504b-2 in the section 500b, the feature averaging is performed on the extracted features of each of the UI components 106. In an example, the feature averaging is based on the base-class weights and a new set of the customized weights assigned to the action category

Now, at block 506b in the section 500b, in continuance with the previous step the weights of the model classifier are updated, and new classes may be added. Thus, the model classifier may include reconstructed weights related to user action 104.

In continuation with the section 500b, at section 500c in the process flow 500-2 may include the ML model 310 determining the user navigation behavior based on the categorized extracted feature, the mapped action category, and the user context to determine the required and the non-required activity in the activity stack 202 during navigation of the UI components 106.

At block 502c in the section 500c, includes the ML model 310 receiving the user action 104 different from the base-class user action. The user action 104 received may be indicative of a new action category.

At block 504c in the section 500c, the features are extracted from the UI components 106 during navigation while the user performs the user action 104.

Now, at block 506c in the section 500c, the adapted weights are created from the reconstructed weights from the section 500b and the reassigned base-class weights based on the user action 104.

At block 508c in the section 500c, the model classifier is updated based on the reassigned base-class weights and the user action 104 for classifying the user action 104 based on the updated model classifier.

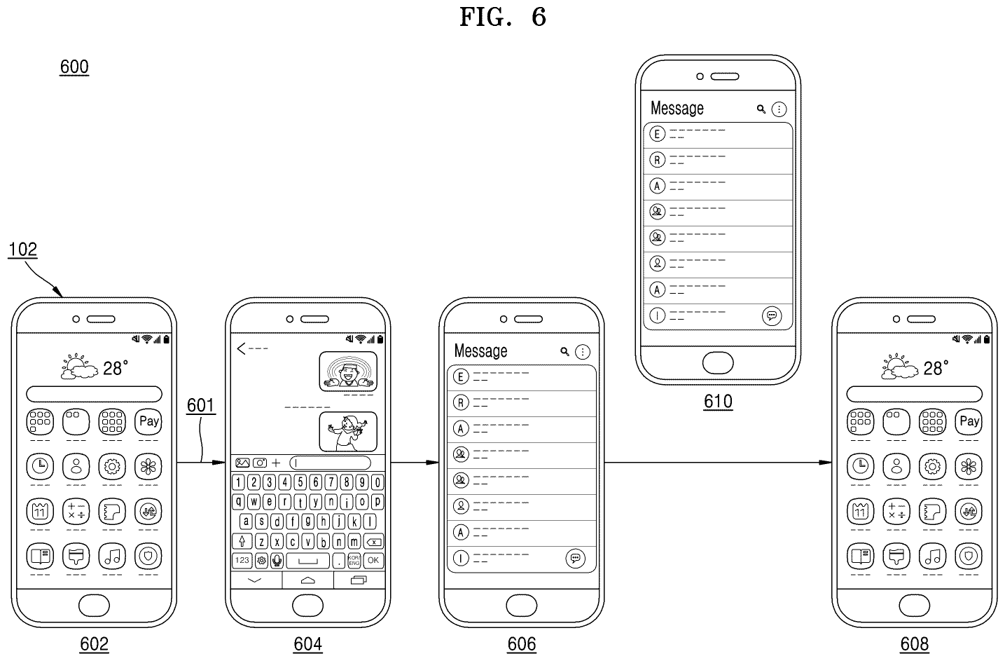

FIG. 6 illustrates a use case 600 for determining a user navigation behavior to determine a required and a non-required activity in an activity stack during navigation according to an embodiment of the disclosure.

Referring to FIG. 6, at operation 602 the UE 102 displays the home screen providing multiple applications or the UI components 106 to the user such that user action 104 associated with navigating the UI components 106 at the UI of the UE 102 may be performed.

At operation 604, the UE 102 displays the messaging application selected by the user. Thus, the user action 104 of selecting the messaging application initiates the user context i.e., the user is likely to message its contacts using the application. In addition, in the activity stack 202, the home-screen is stored as the activity 108 and launch of the messaging application is stored as another activity 108.

At operation 606, the user may select a contact and send a message. Thus, typically the UE 102 displays the message window for the selected contact. The message window is restricted only to chat between the user and the selected contact. The message window may also be added as another activity 108 in the activity stack 202.

Now, at operation 608, as the user presses the back button on the UE 102 for navigation, the disclosure determines the user navigation behavior and provides adaptive navigation on the UE 102 by displaying the home screen. That is, in accordance with the system and method of the disclosure, the activity 108 of the operation 604 is determined as the non-required activity and removed from the activity stack 202 such that during navigation of the UI components, the user receives the activity 108 related to home-screen of operation 602.

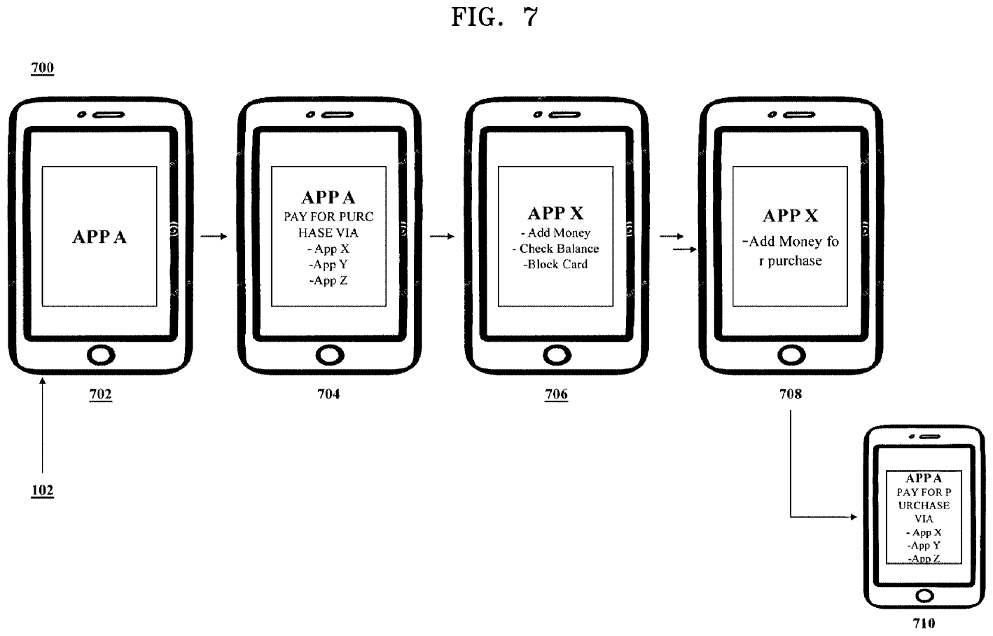

FIG. 7 illustrates a use case 700 for determining a user navigation behavior to determine a required and a non-required activity in an activity stack during navigation according to an embodiment of the disclosure.

Referring to FIG. 7, at operation 702, the UE 102 displays an application ‘A’. The user performs navigation by clicking on the application ‘A’. In an example, the application ‘A’ indicates a shopping application. Thus, the user action 104 is performed by navigating the UI components 106 of the application ‘A’ at the UI of the UE 102.

Now, at operation 704, the UE 102 displays that the user pays for the shopping done in the application ‘A’. In the example, the application ‘A’ may show UI components 106 providing link to other applications for payments. In the example, the user may select an application ‘X’ for making the payments at the application ‘A’. Thus, the user navigating through various UI components 106 at the UI of the application ‘A’ creates the activity 108 related to the payment page of the application ‘A’.

In continuation with the previous operation, at operation 706, the home screen of the application ‘X’is opened thus creating the activity 108 in the activity stack 202.

In continuation, in operation 708, in accordance with the system and method of the disclosure, the user context is obtained from the user action and the activity is determined. For instance, referring to operation 704, as the user performed the user action 104 of making the payment in the application ‘A’, by selecting the application ‘X’, the user context was obtained i.e., the user intends to make a payment through the application ‘X’. Thus, at operation 706, the payment page of application ‘X’ is directly opened.

At operation 710, as the user completes the task of adding money through the application ‘X’ and presses the back button, the user navigation behavior is determined based on the user context. As the user was performing shopping on the application ‘A’ and performed the user action 104 to navigate on the application ‘X’ only for payment, the activity of displaying home screen of the application ‘X’ is determined as the non-required activity and removed from the activity stack 202. Thus, the user is navigated back to the application ‘A’, the activity related to the payment page which is similar to the operation 704.

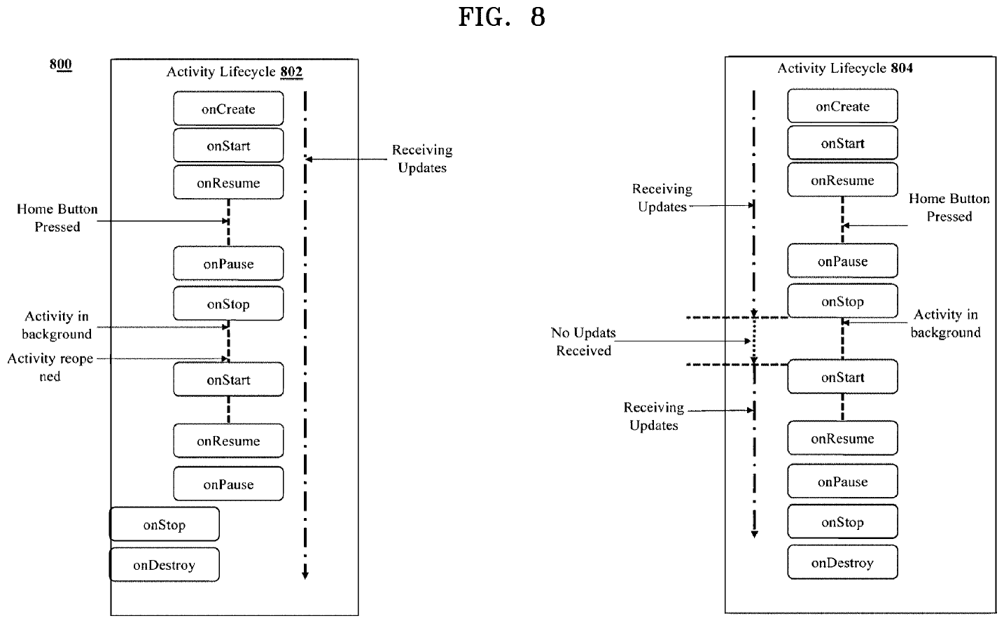

FIG. 8 illustrates a use case for representing a lifecycle of an activity after implementing an adaptive UI navigation on a UE using an ML model according to an embodiment of the disclosure.

Referring to FIG. 8, at block 802 a process flow 800 may represent the lifecycle of the activity 108 without implementation of the adaptive UI navigation on the UE 102. In process flow 800, the ‘onCreate’ function may indicate when the activity 108 is first created in the operating system (OS), say the android in the UE 102.

Further in the process flow 800, ‘onStart’ function may indicate when the activity 108 may become visible to the user on the UI of the UE 102. Now, the ‘onResume’ function is called throughout the lifecycle of the activity 108. The ‘onResume’ function is the counterpart to ‘onPause’ function which may be called anytime the activity 108 is hidden on the UI of the UE 102. For instance, upon starting a new activity 108 that hides it. ‘onResume’ function is called when the activity that was hidden comes back to view on the UI i.e., screen of the UE 102. ‘onPause’ function is called when the user presses the back button on the UE 102 to exit from ongoing activity 108. Thus, the activity 108 is sent to the background.

Further, the ‘onStop’ function is called when the activity 108 is no longer visible on the UI of the UE 102. ‘onStop’ function is called after ‘onPause’ function when the activity 108 goes in background. ‘onStop’ function may be used to stop an application programming interface (API) calls, or the like.

In the process flow 800, when the activity 108 is in the background after calling the ‘onStop’ function, the activity 108 may still receive required updates without implementing the adaptive UI navigation. Such instance may lead to consumption of a lot of UE 102 resources, such as battery, storage, and ram unnecessarily.

At block 804 in the process flow 800, according to implementation of an embodiment of the disclosure the activity 108 may cease to receive updates during the alive phase i.e., between the ‘onCreate’ function and the ‘onPause’ function. Therefore, the disclosure ensures that there is no unnecessary resource wastage of the UE 102.

In an example, with the implementation of the adaptive UI navigation on the UE 102 during the lifecycle of the activity 108, the user navigation behavior indicating the required and the non-required activity in the activity stack 202 is determined. The non-required activities are then removed from the activity stack 202 and the remaining activities 108 which are in the ‘onPause’ function may not receive the update. As the activities with ‘onPause’ function are running in the background, according to the embodiment of the disclosure, such activity 108 may cease to receive the update. Thus, unnecessary resource wastage of the UE 102 is prevented.

According to an embodiment of the disclosure, a method for providing an adaptive user interface (UI) navigation on a user equipment (UE) using a machine learning (ML) model is disclosed. The method includes obtaining a user context from a user action, wherein the user action is associated with navigating a plurality of user interface (UI) components at a UI of the UE. The method includes determining an activity based on the user action, wherein the activity is stored in an activity stack. The method includes extracting at least one feature from the plurality of UI components during navigation based on the user context. The method includes determining at least one action category based on the extracted at least one feature and the user context. The method includes determining a user navigation behavior from the at least one action category and the user context, wherein the user navigation behavior is indicative of learning of at least one required and at least one non-required activity in the activity stack during navigation of the plurality of UI components; and removing the at least one non-required activity from the activity stack such that during navigation one or more of the plurality of UI components are removed providing the adaptive UI navigation on the UE.

According to an embodiment of the disclosure, the method comprises performing a feature averaging on the extracted features of each of the plurality of UI components. And the method comprises assigning a customized weightage to at least one action category, wherein the at least one action category is pre-defined and is corresponding to the user action, and categorizing the extracted features of each of the plurality of UI components into the at least one action category corresponding to the user action based on the customized weightage.

According to an embodiment of the disclosure, the method comprises mapping the at least one action category and the user context. And the method comprises determining the user navigation behavior based on the categorized extracted feature, the mapped at least one action category and the user context to determine the at least one required and the at least one non-required activity in the activity stack during navigation of the plurality of UI components.

According to an embodiment of the disclosure, the method further comprises training the ML model to determine the user navigation behavior from the pre-defined at least one action category. The method comprises determining the plurality of UI components during navigation while performing a base-class user action, wherein the base-class action is indicative of a training-set including the user action. The method comprises assigning a base-class weights to the base-class user action and creating a model classifier for classification of the user action based on the base-class weights to determine the user navigation behavior.

According to an embodiment of the disclosure, the method further comprises determining the user action is different from the base-class user action and reassigning the base-class weights based on the user action to create adapted weights. The method comprises updating the model classifier based on the reassigned base-class weights and the user action and classifying the user action based on the updated model classifier.

According to an embodiment of the disclosure, the method comprises determining a plurality of user actions based on navigation of the plurality of UI component. The method comprises filtering the plurality of user actions to remove at least one non-relevant user action and extracting a plurality of parameters of the plurality of UI components including a touch input, a device orientation, a network condition based on the plurality of user actions. And the method comprises obtaining the user context based on the plurality of user actions and the plurality of parameters.

According to an embodiment of the disclosure, the ML model includes few-shot learning method.

According to an embodiment of the disclosure, the at least one action category indicates a task performed on the UI during the user action.

The disclosure provides various advantages:

The disclosure provides machine learning model which uses less amount of data as few-shot learning technique is applied to train the model determine the user navigation behavior.

The disclosure provides better personalized results for the UI and the user pattern of navigation.

The disclosure provides a secured method to determine the user navigation behavior as the system and method are secured and may not share the user data with any outside entity.

The disclosure provides a machine learning model which continuously trains and learns the user navigation behavior based on the user actions on the UI of the UE.

The disclosure provides an improved performance of the UE or the application as non-required activities are removed from the activity stack.

The disclosure provides faster, more efficient usage of navigation in the UE.

The disclosure prevents back button fatigue in the UE.

The disclosure provides users with meaningful and intelligent navigation control based on the user navigation behavior. Thus, making the navigation process for the user more efficient.

The disclosure provides increased performance of the UE as the ROM and reduces battery consumption by removing the non-required activities from the activity stack.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for providing an adaptive user interface (UI) navigation on a user equipment (UE) using a machine learning (ML) model, the method comprising:
obtaining a user context from a user action, wherein the user action is associated with navigating a plurality of user interface (UI) components at a UI of the UE;
determining an activity based on the user action, wherein the activity is stored in an activity stack;
extracting at least one feature from the plurality of UI components during navigation based on the user context;
determining at least one action category based on the extracted at least one feature and the user context;
determining a user navigation behavior from the at least one action category and the user context, wherein the user navigation behavior is indicative of learning of at least one required and at least one non-required activity in the activity stack during navigation of the plurality of UI components; and
removing the at least one non-required activity from the activity stack such that during navigation one or more of the plurality of UI components are removed providing the adaptive UI navigation on the UE.

2. The method of claim 1, wherein the determining, by the ML model, of the at least one action category comprises:
performing a feature averaging on the extracted features of each of the plurality of UI components;
assigning a customized weightage to at least one action category, wherein the at least one action category is pre-defined and is corresponding to the user action; and
categorizing the extracted features of each of the plurality of UI components into the at least one action category corresponding to the user action based on the customized weightage.

3. The method of claim 2, wherein the determining of the user navigation behavior comprises:
mapping the at least one action category and the user context; and
determining the user navigation behavior based on the categorized extracted feature, the mapped at least one action category and the user context to determine the at least one required and the at least one non-required activity in the activity stack during navigation of the plurality of UI components.

4. The method of claim 1, further comprising:
training the ML model to determine the user navigation behavior from the at least one action category:
determining the plurality of UI components during navigation while performing a base-class user action, wherein the base-class user action is indicative of a training-set including the user action;
assigning a base-class weights to the base-class user action; and
creating a model classifier for classification of the user action based on the base-class weights to determine the user navigation behavior.

5. The method of claim 4, further comprising:
determining the user action is different from the base-class user action;
reassigning the base-class weights based on the user action to create adapted weights;
updating the model classifier based on the reassigned base-class weights and the user action; and
classifying the user action based on the updated model classifier.

6. The method of claim 1, wherein the obtaining of the user context comprises:
determining a plurality of user actions based on navigation of the plurality of UI component;
filtering the plurality of user actions to remove at least one non-relevant user action;
extracting a plurality of parameters of the plurality of UI components including a touch input, a device orientation, a network condition based on the plurality of user actions; and
obtaining the user context based on the plurality of user actions and the plurality of parameters.

7. The method of claim 1, wherein the ML model includes few-shot learning method.

8. The method of claim 1, wherein the at least one action category indicates a task performed on the UI during the user action.

9. A user equipment (UE) or providing an adaptive user interface (UI) navigation using a machine learning (ML) model, the UE comprising:
memory storing one or more computer programs; and
one or more processors communicatively coupled to the memory,
wherein the one or more computer programs include computer-executable instructions that, when executed by the one or more processors individually or collectively, cause the UE to:
obtain a user context from a user action, wherein the user action is associated with navigating a plurality of user interface (UI) components at a UI of the UE,
determine an activity based on the user action, wherein the activity is stored in an activity stack,
extract at least one feature from the plurality of UI components during navigation based on the user context,
determine at least one action category based on the extracted at least one feature and the user context,
determine a user navigation behavior from the at least one action category and the user context, wherein the user navigation behavior is indicative of learning of at least one required and at least one non-required activity in the activity stack during navigation of the plurality of UI components, and
remove the at least one non-required activity from the activity stack such that during navigation one or more of the plurality of UI components are removed providing the adaptive UI navigation on the UE.

10. The UE of claim 9, wherein the one or more computer programs further include computer-executable instructions that, when executed by the one or more processors individually or collectively, cause the UE to:
perform a feature averaging on the extracted features of each of the plurality of UI components,
assign a customized weightage to at least one action category, wherein the at least one action category is pre-defined and is corresponding to the user action, and
categorize the extracted features of each of the plurality of UI components into the at least one action category corresponding to the user action based on the customized weightage.

11. The UE of claim 10, wherein the one or more computer programs further include computer-executable instructions that, when executed by the one or more processors individually or collectively, cause the UE to:
map the at least one action category and the user context obtained from the user action, and
determine the user navigation behavior based on the categorized extracted feature, the mapped at least one action category and the user context to determine the at least one required and the at least one non-required activity in the activity stack during navigation of the plurality of UI components.

12. The UE of claim 9, wherein the one or more computer programs further include computer-executable instructions that, when executed by the one or more processors individually or collectively, cause the UE to:
determine the user navigation behavior from the at least one action category,
determine the plurality of UI components during navigation while performing a base-class user action, wherein the base-class user action is indicative of a training-set including the user action,
assign a base-class weights to the base-class user action, and
create a model classifier for classification of the user action based the base-class weights to determine the user navigation behavior.

13. The UE of claim 12, wherein the one or more computer programs further include computer-executable instructions that, when executed by the one or more processors individually or collectively, cause the UE to:
determine the user action is different from the base-class user action,
reassign the base-class weights based on the user action to create adapted weights,
update the model classifier based on reassigned base-class weights and the user action, and classifying the user action based on the updated model classifier.

14. The UE of claim 9, wherein the one or more computer programs further include computer-executable instructions that, when executed by the one or more processors individually or collectively, cause the UE to:
determine a plurality of user actions based on navigation of the plurality of UI components during the user action,
filter the plurality of user actions to remove at least one non-relevant user action,
extract a plurality of parameters of the plurality of UI components including a touch input, a device orientation, a network condition based on the user actions, and
obtain the user context based on the user actions and the plurality of parameters.

15. The UE of claim 9, wherein the ML model includes few-shot learning method.

16. The UE of claim 9, wherein the at least one action category indicates a task performed on the UI during the user action.

17. One or more non-transitory computer-readable storage media storing computer-executable instructions that, when executed by one or more processors of a user equipment individually or collectively, cause a user equipment (UE) to perform operations, the operations comprising:
determining an activity based on a user action, wherein the activity is stored in an activity stack;
extracting at least one feature from a plurality of UI components during navigation based on a user context;
determining at least one action category based on the extracted at least one feature and the user context;
determining a user navigation behavior from the at least one action category and the user context, wherein the user navigation behavior is indicative of learning of at least one required and at least one non-required activity in the activity stack during navigation of the plurality of UI components; and
removing the at least one non-required activity from the activity stack such that during navigation one or more of the plurality of UI components are removed providing adaptive UI navigation on the UE.

18. The one or more non-transitory computer-readable storage media of claim 17, wherein the determining, by ML model, of the at least one action category comprises:
performing a feature averaging on the extracted features of each of the plurality of UI components;
assigning a customized weightage to at least one action category, wherein the at least one action category is pre-defined and is corresponding to the user action; and
categorizing the extracted features of each of the plurality of UI components into the at least one action category corresponding to the user action based on the customized weightage.

19. The one or more non-transitory computer-readable storage media of claim 18, wherein the determining of the user navigation behavior comprises:
mapping the at least one action category and the user context; and
determining the user navigation behavior based on the categorized extracted feature, the mapped at least one action category and the user context to determine the at least one required and the at least one non-required activity in the activity stack during navigation of the plurality of UI components.

20. The one or more non-transitory computer-readable storage media of claim 19, the operations further comprising:
training the ML model to determine the user navigation behavior from the pre-defined at least one action category:
determining the plurality of UI components during navigation while performing a base-class user action, wherein the base-class user action is indicative of a training-set including the user action;
assigning a base-class weights to the base-class user action; and
creating a model classifier for classification of the user action based on the base-class weights to determine the user navigation behavior.
